(19) United States
(12) Patent Application Publication
(10) Pub. No.: US 2009/0100051 A1
(43) Pub. Date: Apr. 16, 2009

(54) DIFFERENTIATED TREATMENT OF SPONSORED SEARCH RESULTS BASED ON SEARCH CONTEXT

(75) Inventors: Rushi Bhatt, Bangalore (IN); Jignashu Parikh, Gujarat (IN); Rajesh Girish Parekh, Mountain View, CA (US); Pavel Berkhin, Sunnyvale, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 11/870,008

(22) Filed: Oct. 10, 2007

(51) Int. Cl. G06F 17/30

(52) U.S. Cl. 707/6; 707/E17.039

(57) ABSTRACT

Methods and apparatus are described for presenting sponsored search results. A user is enabled to initiate a search from a context. The sponsored search results and organic search results are presented in a search results page in response to the search, an order of the sponsored search results and placement of subsets of the sponsored search results relative to the organic search results in the search results page having been determined with reference to contextual information relating to the context.

### BACKGROUND OF THE INVENTION

The present invention relates to online advertising and, in particular, to the ordering and placement of sponsored search results in search results pages.

Users of the World Wide Web are familiar with the various services available on the Web for locating content of interest. Search engines are provided by a number of entities and search capabilities are embedded in many web sites. Web users are also familiar with the manner in which search results are presented by the various search engines and utilities.

“Organic” search results (i.e., search results which appear because they have some objective measure of relevance to the keywords of the search query) are typically presented on the left hand side (i.e., the West) of a search results page. In addition, “sponsored” search results (i.e., search results which appear because the sponsors have paid for placement in response to specific search keywords) are also presented in search results pages at a variety of locations including at the top (i.e., the North), the right hand side (i.e., the East), and the bottom (i.e., the South) of the search results page. A wide variety of sophisticated algorithms have been developed for identifying, ranking, and placing sponsored search results with the intent of enhancing the likelihood that users viewing search results pages will select them. As this sort of advertising is part of the economic foundation of the Web and the Internet, continued advancement in the performance of such algorithms is desirable.

### SUMMARY OF THE INVENTION

According to one class of embodiments, methods and apparatus are provided for generating sponsored search results. In response to a search query, the sponsored search results are generated for presentation with organic search results responsive to the search query. An order of the sponsored search results is determined with reference to first contextual information relating to a context from which the search query originated. Placement of subsets of the sponsored search results relative to the organic search results in a search results page is determined with reference to second contextual information relating to the context.

According to another class of embodiments, methods and apparatus are provided for presenting sponsored search results. A user is enabled to initiate a search from a context. The sponsored search results and organic search results are presented in a search results page in response to the search, an order of the sponsored search results and placement of subsets of the sponsored search results relative to the organic search results in the search results page having been determined with reference to contextual information relating to the context.

A further understanding of the nature and advantages of the present invention may be realized by reference to the remaining portions of the specification and the drawings.

### BRIEF DESCRIPTION OF THE DRAWINGS

FIG. 1 is a flowchart illustrating the operation of a specific embodiment of the invention.

FIG. 2 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

From analysis of the behavior of users of search engines, we determined that there is a significant correlation between the context from which a search originates and the likelihood that users will select a sponsored search result. For example, where the originating page could be characterized as more commercial in nature, e.g., a product comparison page, we determined that there is a greater likelihood that users will select sponsored search results, particularly those relating to the product represented on the originating page. Moreover, similarities between search query terms or keywords and the context from which a search was initiated tend to support an inference of a strong user focus on a specific task rather than a general navigational intent. Therefore, embodiments of the present invention employ information relating to the context (e.g., the originating page or site) from which a search originates to inform the ranking and placement of sponsored search results.

According to various embodiments of the invention, the context from which a search originated may be determined in a variety of ways and to varying degrees of detail. For example, in ecosystems like Yahoo!®, the context may represent any of a number of high level “properties” or categories of content within the ecosystem, e.g., Yahoo!® Finance, Yahoo!® Autos, etc., which may be identified, for example, with reference to the Universal Navigation Header (UNH) that is present on all Yahoo!® web pages.

Alternatively, the context may be determined at a more granular level with reference to the actual content on a web page or web site, e.g., analyzing the content on a page or related pages to determine the main keywords, identify titles of images, etc. In another example, a search initiated in a browser toolbar (e.g., a Yahoo!® toolbar) often indicates the site or page to which the browser pointed, e.g., the referrer field, when the search was initiated. This information is thus representative of the context from which the search originated.

Once determined, the contextual information relating to the originating context of the search may then be leveraged in determining an ordering or ranking of sponsored search results responsive to the search. This may be done in combination with other information such as, for example, the query term(s) or keyword(s), the advertiser and content associated with the sponsored search results, the advertisers' bids, etc.

In addition, the contextual information may be further leveraged to determine whether and how many sponsored search results should be placed in various locations in the search results page relative to the organic search results, e.g., in the North, East, and South. That is, placement of sponsored search results to the North of the organic search results is generally considered to be desirable in that those are the first search results seen by the user. If it can be inferred that a particular user is likely to select a sponsored search result (e.g., has a task-specific intent which is commercial in nature), then placement of sponsored search results in the North is highly desirable.

On the other hand, where a user is unlikely to select a sponsored search result (e.g., has a task-specific intent which is not commercial in nature), any negative impact on the user's experience associated with placing search results in the North has little or no offsetting economic benefit, and therefore such prominent placement of sponsored search results may be undesirable. The use of contextual information as enabled by specific embodiments of the present invention allows a balance to be struck between these competing concerns.

Some examples may be instructive. If a user is viewing a web page in the Yahoo!® Autos property which describes an SUV from a particular auto manufacturer, but enters a more generic search query, e.g., “new cars,” the contextual information derived from the content of the page, i.e., that it relates to an SUV, could be used to influence the ranking of sponsored search results to favor ads relating to SUVs. Thus, information from the user's context may be employed to come up with a ranking which would be considerably different without this information, i.e., if only the query and information derived from the query were used.

In addition, if it is also determined that the originating web page includes pricing information from various dealers for the described SUV, this information may be used to affect the distribution of the ranked sponsored search results on the search results page. That is, because the user's context supports an inference of a task-specific intent which is commercial in nature, i.e., at least some level of interest in purchasing an SUV, it can further be inferred (e.g., from past behavioral analysis) that this user represents a greater likelihood of selection of a sponsored search result. This, in turn, supports a decision to place at least some of the sponsored search results to the North of the organic search results.

On the other hand, if the originating page relates to futuristic auto designs, this might support an inference that the query is not particularly commercial in nature, and therefore a decision that fewer or no sponsored search results be placed in the North. Thus, the contextual information again potentially results in a different user experience for the same query depending on the originating context.

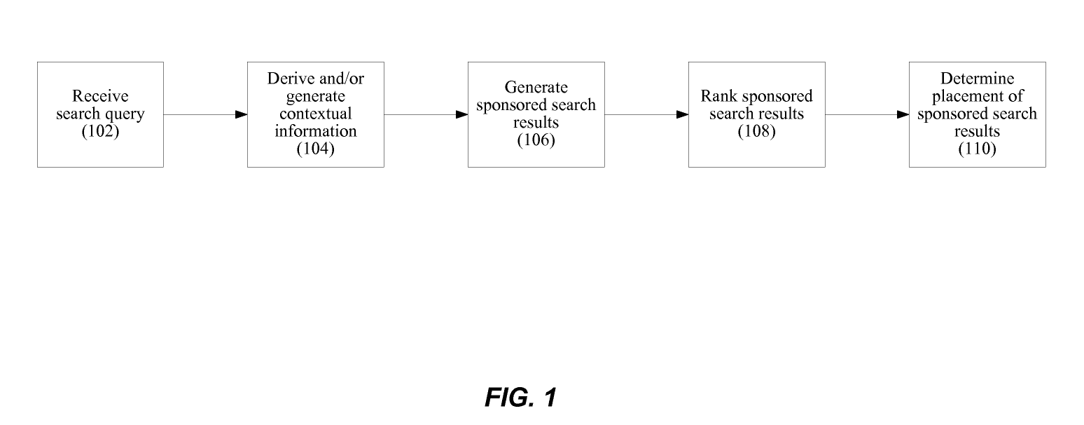

FIG. 1 is a flowchart illustrating operation of a specific embodiment of the invention. When a query is received (102), contextual information relating to the context in which the search query originated is derived and/or generated (104). Sponsored search results are generated for presentation with organic search results for that query (106). The sponsored search results are responsive to the query term(s) or keyword(s) and may be generated using any of a wide variety of algorithms and relevancy measures. According to various embodiments, the contextual information may be used not only to rank and place sponsored search results (described below), but also to identify relevant sponsored results from a pool of matching sponsored search results.

As mentioned above, this contextual information may relate to a number of different aspects or characteristics of the context from which the search was initiated, i.e., the originating context, and may be derived or generated in a variety of ways. For example, the contextual information might include additional keywords derived from the originating context (either directly or indirectly), content, product, or service categories related to the originating context, image information (e.g., captions or descriptive text), the source or provider associated with the originating context (e.g., a corporate entity as determined by the URL or a referrer field), the commercial nature of the context, etc.

The contextual information may also include the nature of the relationship between the originating context and the search query. That is, similarity between the terms or keywords included in the search query and content associated with the originating context may indicate a task-specific intent or focus by the user which, in turn, could be used to affect ranking and/or placement. More generally, any information relating to the context in which the search is initiated may be considered contextual information for use with embodiments of the present invention.

The sponsored search results are then ranked with reference to some portion (and perhaps all) of the contextual information (108). The contextual information may be employed as additional input to existing (or slightly modified) ranking algorithms, or be used as input to entirely new and/or ancillary ranking algorithms. According to a specific embodiment, the algorithm or function by which the ranking is achieved is representative of a relationship between expected revenue for the sponsored search result and the contextual information.

As mentioned above, the ranking may also be done with reference to various additional information such as, for example, the search query itself, as well as information relating to each of the sponsored search results. Information about the query might include, for example, the keyword(s) included in the query, historical performance for the keyword(s) (e.g., as represented by click-through rates or the like), etc. Information about each sponsored search result might include, for example, the advertiser, the advertiser's bid on the keyword(s), content of the sponsored search results (e.g., title, text, etc.), the URL to which the sponsored search result is pointing, etc.

Returning to the SUV example mentioned above, the keyword “SUV” could be derived from the Yahoo!® Autos web page from which the user initiated the search. Use of this additional keyword in ranking the sponsored search results returned in response to the search query “new cars” might then result in higher rankings for sponsored search ads relating to SUVs than would otherwise occur using conventional ranking techniques given the generic nature of the query. This, in turn, may have the effect of enhancing revenue in view of the inference that the user has a specific interest in SUVs as determined from the originating context of the search.

According to some embodiments, placement of the sponsored search results on the search results page (e.g., apportionment of the results among the North, East, and South sections of the page) is determined with reference to some portion (possibly all) of the contextual information (110). It should be noted that the order in which the ranking of sponsored search results and the placement of sponsored search results occurs may vary without departing from the invention. For example, the placement determination may occur subsequent to the ranking of sponsored search results as indicated in FIG. 1. However, implementations of the invention are contemplated in which a placement schema is determined prior to ranking the sponsored search results.

According to specific embodiments, the subset of the contextual information used to determine placement may or may not be the identical subset of the contextual information with which the ranking of sponsored search results is achieved. For example, the ranking algorithm might primarily employ additional keywords derived from the originating context, while the placement algorithm might primarily employ evidence of the user's task-specific intent. In addition, one or the other of these algorithms might leverage the results of the other, e.g., the placement algorithm might leverage or employ the results of the ranking algorithm, or may employ an entirely unrelated algorithm.

And as with the ranking algorithm, the placement of the sponsored search results may additionally be determined with reference to other information such as, for example, the search query and the results in the ordered list. As discussed above, the apportionment of results among the available locations in a search results page attempts to strike a balance between ad performance and user experience by presenting sponsored search results more prominently when there appears to be a higher likelihood that the user will select a sponsored search result, e.g., where similarities between the search query and the context in which it originated indicate that the user is exhibiting a task-specific intent which is commercial in nature.

According to various embodiments, the manner in which the sponsored search results are apportioned among the available location options may vary considerably from the very simple to the relatively complex. For example, in a relatively simple embodiment in which the sponsored search results are apportioned among the North, East, and South of a search results page, some fixed number of results (e.g., 3) are placed in the North (i.e., above the organic search results) where it has been determined that the underlying query is “commercial” in nature, i.e., represents a likelihood that the user will select a sponsored search result. On the other hand, no sponsored search results are placed in the North if the underlying query is determined to be “non-commercial” in nature.

According to such a binary approach, the apportionment of sponsored search results in the East and South may or may not directly result from the North apportionment. That is, for example, display of sponsored search results in the South might only occur where no results are displayed in the North. Or, for example, the number of sponsored search results in the East may remain static, or be tied to the number displayed in the North.

As an alternative to the binary “commercial” versus “non-commercial” approach described above, a more sophisticated algorithm could be employed in which the number of sponsored search results in each of the available location options (e.g., North, East, and South) varies with the predicted probability that the particular user will select a sponsored search result. So, for example, no sponsored search results might be displayed in the North if the user represents less than a 25% likelihood of selecting one; one if the user represents a likelihood between 25% and 50%; two if between 50% and 75%; and three if above 75%. Again, the number of search results in the East and South may have varying levels of dependency on the number displayed in the North.

As yet another alternative, the number of sponsored search results in each or multiple sections of the search results page may be determined explicitly. The apportionment may be determined dynamically, i.e., for each set of search results, or be selected from preexisting configurations of sponsored search results. As will be understood with reference to the foregoing examples, the variations within the scope of the invention are considerable.

Another example relating to placement of sponsored search results in a search results page may be instructive. Suppose the user initiated a search in which the query included the keyword “SUV.” Conventionally, such a keyword would be considered highly commercial in nature, highly profitable from an ad revenue point of view, and would result in a number of sponsored search results from advertisers trying to sell SUVs. And because of its highly commercial nature, it might be assumed that it is desirable to place sponsored search results prominently, e.g., to the North of the organic search results.

However, suppose further that the user actually initiated the search from an auto mechanics web site and, in particular, from a page which contains detailed information relating to an SUV fuel system. Using this information, it might instead be determined that there is a very low likelihood that the user will select a sponsored search result (i.e., because it may be inferred that the user is seeking information for some non-commercial purpose, e.g., troubleshooting a fuel system problem), and that therefore no sponsored search results should be placed in the North. Rather, the first search result seen by the user is the top organic search result which presumably corresponds more closely to the user's search query and therefore a more positive experience for the user than one or more irrelevant sponsored search results. Thus, contextual information may be employed to affect the search experience in a way which is likely to be more aligned with what the user is actually trying to accomplish.

According to one application of the present invention, where reference to the originating context of a search query supports an inference of task-specific intent which is commercial in nature, sponsored search results for specific advertisers who have agreed to pay a premium “cost per click” or “CPC” for such search queries may be featured more prominently, thus introducing an additional mechanism for affecting the ranking and/or placement of sponsored search results based on the originating context.

According to another application, context may be employed to disambiguate search queries. That is, information derived from the originating context of a search query can be employed to better match, i.e., rank and/or place, sponsored search results to the user's intent. For example, suppose a user initiates a search using the keyword “opera.” Sponsored search results might be returned relating to operatic music, e.g., the Metropolitan Opera, as well as technical literature, e.g., the Opera browser on FreeBSD. According to a specific embodiment of the present invention, the ranking and placement of these disparate results may be done with reference to the originating context so that the more relevant results are featured more prominently. Thus, for example, if the user initiated the search from a web page relating to browser technology, the latter class of sponsored search results would be featured more prominently.

In another example, the search term “mortgage” typically results in sponsored search results being returned which relate to both initial or primary mortgages as well as refinancing. If the user initiated the search from a page relating to refinancing, the present invention may be employed to feature the results relating to refinancing more prominently. As will be understood with reference to the examples described herein, embodiments of the present invention may employ contextual information, i.e., information relating to the context in which a search originated, in a wide variety of ways to affect the ranking and/or placement of sponsored search results in a search results page.

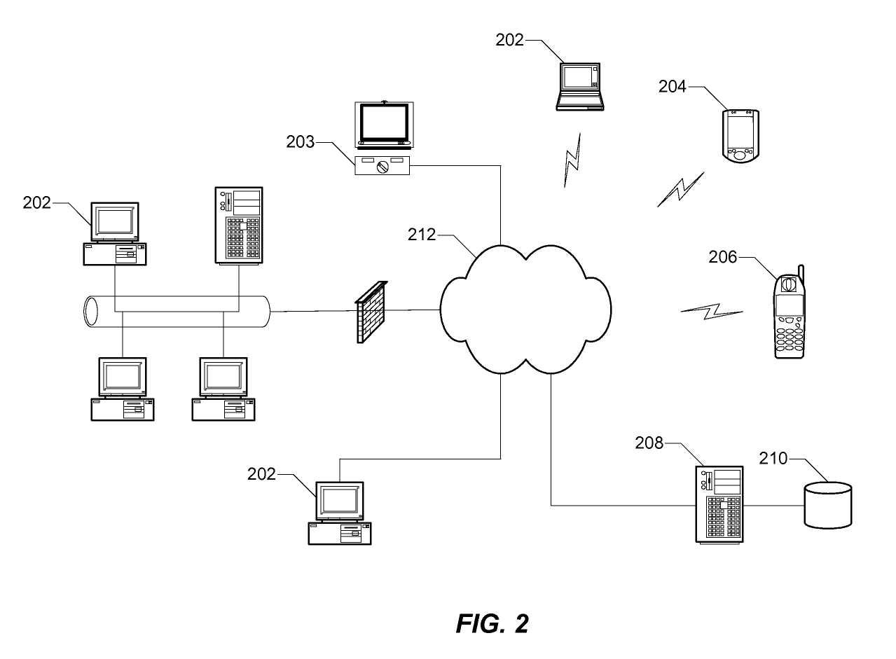

Embodiments of the present invention may be employed to rank and/or determine placement of sponsored search results in any of a wide variety of computing contexts and in conjunction with any of a wide variety of search technologies. For example, as illustrated in FIG. 2, implementations are contemplated in which the relevant population of users interacts with a diverse network environment via any type of computer (e.g., desktop, laptop, tablet, etc.) 202, media computing platforms 203 (e.g., cable and satellite set top boxes and digital video recorders), handheld computing devices (e.g., PDAs) 204, cell phones 206, or any other type of computing or communication platform.

And according to various embodiments, contextual information employed by such embodiments may be derived and/or generated using a wide variety of techniques. For example, derivation and/or generation of data representing the context in which a search is initiated, or a user's interaction with a web site or a search engine or other web-based application or service may be accomplished using any of a variety of well known mechanisms for acquiring information about a web page or web site, or recording a user's online behavior.

Once determined, these contextual data are employed in conjunction with, for example, search query terms and information about responsive sponsored search results to rank and/or determine placement of sponsored search results according to the invention. This is represented in FIG. 2 by server 208 and data store 210 which, as will be understood, may correspond to multiple distributed devices and data stores. Server 208 and data store 210 may also represent the underlying search engine and related functionalities. That is, the use of contextual data in accordance with the invention may be integrated with the operation of the search engine or, alternatively, be implemented separately and work in combination with the search engine.

The invention may also be practiced in a wide variety of network environments (represented by network 212) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, in the specific embodiment shown and described with reference to FIG. 1, generation of contextual information is shown occurring prior to generation of sponsored search results. This allows for the use of contextual information in the generation or selection of the sponsored search results. However, it should be understood that contextual information can be generated in parallel with or subsequent to the generation of the sponsored search results without departing from the invention. More generally, the order in which various process steps may be described in the various implementations discussed herein should not be viewed as limiting the scope of the invention.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for generating sponsored search results, comprising:
in response to a search query, generating the sponsored search results for presentation with organic search results responsive to the search query;
determining an order of the sponsored search results with reference to first contextual information relating to a context from which the search query originated; and
determining placement of subsets of the sponsored search results relative to the organic search results in a search results page with reference to second contextual information relating to the context.

2. The method of claim 1 wherein each of the first and second contextual information comprises one or more of at least one additional keyword derived from the context, a subject matter category related to the context, image information derived from the context, an entity associated with the context, a measure of commerciality of the context, or a relationship between the context and the search query.

3. The method of claim 1 further comprising determining the first and second contextual information with reference to one or more of a URL associated with the context, a referrer field associated with the context, or content associated with the context.

4. The method of claim 1 wherein the order of the sponsored search results is further determined with reference to bids by sponsors of the sponsored search results, the bids being dependent on at least some of the first and second contextual information.

5. The method of claim 1 wherein the first and second contextual information are one of: the same, overlapping, or mutually exclusive.

6. The method of claim 1 further comprising facilitating presentation of the sponsored search results and the organic search results in the search results page in accordance with the order and the placement.

7. A system for generating sponsored search results, comprising at least one computing device configured to:
in response to a search query, generate the sponsored search results for presentation with organic search results responsive to the search query;
determine an order of the sponsored search results with reference to first contextual information relating to a context from which the search query originated; and
determine placement of subsets of the sponsored search results relative to the organic search results in a search results page with reference to second contextual information relating to the context.

8. The system of claim 7 wherein each of the first and second contextual information comprises one or more of at least one additional keyword derived from the context, a subject matter category related to the context, image information derived from the context, an entity associated with the context, a measure of commerciality of the context, or a relationship between the context and the search query.

9. The system of claim 7 wherein the at least one computing device is further configured to determine the first and second contextual information with reference to one or more of a URL associated with the context, a referrer field associated with the context, or content associated with the context.

10. The system of claim 7 wherein the order of the sponsored search results is further determined with reference to bids by sponsors of the sponsored search results, the bids being dependent on at least some of the first and second contextual information.

11. The system of claim 7 wherein the first and second contextual information are one of: the same, overlapping, or mutually exclusive.

12. The system of claim 7 wherein the at least one computing device is further configured to facilitate presentation of the sponsored search results and the organic search results in the search results page in accordance with the order and the placement.

13. A computer program product for generating sponsored search results, comprising at least one computer-readable medium having computer program instructions stored therein which are operable when executed by at least one computing device to:
in response to a search query, generate the sponsored search results for presentation with organic search results responsive to the search query;
determine an order of the sponsored search results with reference to first contextual information relating to a context from which the search query originated; and
determine placement of subsets of the sponsored search results relative to the organic search results in a search results page with reference to second contextual information relating to the context.

14. A computer-implemented method for presenting sponsored search results, comprising:
enabling a user to initiate a search from a context; and
facilitating presentation of the sponsored search results and organic search results in a search results page in response to the search, an order of the sponsored search results and placement of subsets of the sponsored search results relative to the organic search results in the search results page having been determined with reference to contextual information relating to the context.

15. The method of claim 14 wherein the contextual information comprises one or more of at least one additional keyword derived from the context, a subject matter category related to the context, image information derived from the context, an entity associated with the context, a measure of commerciality of the context, or a relationship between the context and the search query.

16. The method of claim 14 wherein the contextual information was determined with reference to one or more of a URL associated with the context, a referrer field associated with the context, or content associated with the context.

17. The method of claim 14 wherein the order of the sponsored search results was further determined with reference to bids by sponsors of the sponsored search results, the bids being dependent on at least some of the first and second contextual information.

18. The method of claim 14 wherein the order and the placement were determined with reference to first and second portions of the contextual information, respectively, the first and second portions being one of: the same, overlapping, or mutually exclusive.

19. A system for presenting sponsored search results, comprising at least one computing device configured to:
enable a user to initiate a search from a context; and
facilitate presentation of the sponsored search results and organic search results in a search results page in response to the search, an order of the sponsored search results and placement of subsets of the sponsored search results relative to the organic search results in the search results page having been determined with reference to contextual information relating to the context.

20. The system of claim 19 wherein the contextual information comprises one or more of at least one additional keyword derived from the context, a subject matter category related to the context, image information derived from the context, an entity associated with the context, a measure of commerciality of the context, or a relationship between the context and the search query.

21. The system of claim 19 wherein the contextual information was determined with reference to one or more of a URL associated with the context, a referrer field associated with the context, or content associated with the context.

22. The system of claim 19 wherein the order of the sponsored search results was further determined with reference to bids by sponsors of the sponsored search results, the bids being dependent on at least some of the first and second contextual information.

23. The system of claim 19 wherein the order and the placement were determined with reference to first and second portions of the contextual information, respectively, the first and second portions being one of: the same, overlapping, or mutually exclusive.
